(19) United States
(12) Patent Application Publication
(10) Pub. No.: US 2014/0365379 A1
(43) Pub. Date: Dec. 11, 2014

(54) Sales services system

(71) Applicant: Ho Keung TSE, Hong Kong (HK)

(72) Inventor: Ho Keung TSE, Hong Kong (HK)

(21) Appl. No.: 13/986,822

(22) Filed: Jun. 10, 2013

(51) Int. Cl. G06Q 30/00; G06Q 30/02

(52) U.S. Cl. CPC G06Q 30/016; G06Q 30/0281
USPC 705/304

(57) ABSTRACT

A method for providing a period of trial use of a touch screen electronic device to a user and providing sales support services to the user, in which the device sends screen display information to a server so that it can present the display information to a human or software with artificial intelligence, for helping the customer to learn how to use the device, through cursor activities on the touch screen of electronic device.

### FIELD OF THE INVENTION

The present invention relates to sales support services, and particularly, to sales support services for electronic devices.

### BACKGROUND OF THE INVENTION

Nowadays, electronic devices with a touch screen are commonly found and used as portable phones, computers etc.

Those devices are expensive with complex functions, rendering them impossible to be offered for a potential customer to fully try their functionalities before purchasing them.

One objective of the present invention is to provide sales support services to a customer of such a device, to facilitate the customer to use its functionality before and after purchasing it.

### BRIEF DESCRIPTION OF THE DRAWING

FIG. 1 is a diagrammatic view of the information shown on a customer service representative's computer screen display.

### DETAILED DESCRIPTION OF THE PREFERRED EMBODIMENTS

According to an embodiment of the present invention, there is provided an electronic device 1 with a touch screen 2.

The device 1 may be supplied to a user for trial use, for a short period, say, 7 days, after the device 1 being sold to the user. Within that trial use period, the user may return the device 1 for a full refund, if the performance is not satisfactory,

Whenever the device 1 is switched on, it will automatically record the duration of switch-on time into its memory in a confidential manner, and if it has been switched on a number of times, it will add all the durations of the switched on time it has recorded together, to obtain a sum, and further compare the sum with a predetermined limit X, says, 2 hours, and once the sum reaches the predetermined limit, the device 1 will further record down the date and time of the predetermined limit being reached. The date will be the date of commencement of the trial use period (during which the above-mentioned refund request may be entertained unconditionally), or alternatively warranty period (unconditional refund request no longer entertained, only maintenance service may be offered).

In this way, a user is provided with a short period time for inspection of the functionality of device 1, without triggering the commencement of the trial use period, or warranty period, before the user is actually prepared to use device 1, or even to buy device 1. In an alternative embodiment, if the device 1 is a portable one, the device 1 will not record the duration of switched on time, when the device 1 detects that it is connected electrically with charger or a computer, says, by means of a cable, by sensing that an voltage is applied to its electrical contacts accessible externally which may be a charging port, a USB port, or alternatively, device 1 authenticates the identity of the computer, by requesting the computer to provide it a piece confidential information through the USB connection, such as encryption by the computer of a random number provided by device 1, and device 1 will check the correctness of the result by doing the encryption on its own, and if the result is correct, then the device 1 will determined that it itself is connected to a computer.

In this way, the duration will not be added into the sum, so that a user may have some extra time to try out device 1, before normal usage, for the sake of flexibility.

Furthermore, the device 1 may also monitor the amount of its memory storage being used up by a user and trigger the commencement of the trial use period, or warranty period automatically once the memory being used up reaches or exceeds a predetermined limit Y, even though the above-mentioned sum of switched on durations is below the above-mentioned predetermined limit X. Specifically, whenever a file which may be a music file, a movie file, an application program, is transferred into the memory storage of device 1, device 1 will determine if the total amount of memory being used up for storing all such files, reaches or exceeds the predetermined limit Y. If the limit Y is reached or exceeded, then device 1 will record the date and time that the limit Y is reached or exceeded, which will be used as the date of commencement of the trial use period, or warranty period. Or alternatively, before transferring a file to its memory, device 1 will determine if the transfer will cause the total amount of memory being used up for storing all such files, reaches or exceeds the predetermined limit Y, if so, then device 1 will alert the user of device 1 by displaying a message for this purpose on touch screen 2, and perform the transfer unless obtain a confirmation on the transfer from the user.

The device 1 will calculate itself the date that the trial use period or warranty period will expire by adding a predetermined number of days to the recorded date of commencement, and the device 1 will display the recorded date and time of commencement, as well as the expiration date on touch screen 2, upon receiving a specific command, or when a user taps a particular button.

And, once the device 1 is being connected to Internet, it will automatically send the recorded date of commencement of the trial use period, or warranty period, and calculated expiration dates for trial use period, or warranty period, as well as an serial number and model number stored in device 1 and for identifying device 1, directly or indirectly to the seller of device 1 in a confidential manner, by sending the same to, says, an email address of the seller which being stored in the memory of the device 1.

Then, a server 3 of the seller will receive the email and will store the information in the email received from device 1, together with any other information related to device 1, such as history of device 1 including maintenance information such as date and result of quality control check, date of first shipping out of factory, and date and reason of returning to factory, if any (which may be supplied to the server 3 by means of keyboard entry by a human), into a record associated with the device and the record will be made available for to be downloaded through internet at a predetermined URL (uniform resource locator).

Alternatively, device 1 will not respond to any user command to perform any function, before it is activated for normal use, except that it may be connected to the server 3, through Internet, for the activation. Once so connected and requested by a user for the activation, device 1 will send its serial number and model number to server 3, and server 3 will record the serial number and model number, and use the date of receipt of the serial number and model number as the date of commencement of the trial use period, or warranty period, for device 1, and also send a command, in a confidential manner, to device 1 to authorize it to become fully functional. However, in order for a potential customer to have an opportunity of testing the functionality of device 1, before making a purchase decision, when the device 1 detected that it is connected electrically with charger or a computer, says, by means of a cable etc., by techniques as mentioned above.

Or, device 1 will perform any function as commanded by a user and is fully functional, however, it will refuse to do so if it detects its memory has been used in storing files of its user(s) reaches a predetermined limit Y, unless it is activated. Additionally, a limit Z may be imposed on the total time for testing, in the manner as disclosed above, if the total time accumulated reaches the limit Z, the device 1 will not respond to any user command to perform any function, unless it is activated.

Further, the device 1 may make use of the Global Positioning System (“GPS”) installed inside it to determine the position of itself and allow the testing to be performed at a specific location only, such as a retail shop responsible for selling device 1 or the location it is first time charged which may be the home of a buyer, by checking the present location of device 1 determined with that of the retail shop pre-installed in device 1's memory or the location device 1 is first time charged (which is obtained by device 1 itself when it is firstly charged, by using GPS), and allow the testing only if the checking result is positive.

And, instead of device 1 itself, server 3 may be used for monitoring, recording the duration time of testing, checking if the total testing time accumulated exceeds a limit and stopping further testing by issuing a specific command signal to device 1 if the limit exceeded, and the device 1 has to be connected to server 3, via Internet, by a specific application program S in the manner as disclosed below, in order that server 3 can issue another specific command signal to device 3 for allowing the testing to be performed.

And, if a specific application program S of the device 1 is caused to be executed by a user, the application program S will automatically communicate with the server 3 by using the predetermined URL, through Internet and send the serial number and model number of the device 1 to the server 3 in a confidential manner (for e.g., by encryption, to as to prevent unauthorized use of the server 3's service), and the server 3 in response, will send to device 1 the above record. The program S will display information in the record, together with the sum of switched on durations of device 1 as mentioned above and stored in the memory of device 1 itself, on touch screen 2. The sum is displayed in day, hour, minute, second format and constantly updated. Providing maintenance history to a potential buyer of the device can give him an insight into what has happened to the device, before making a purchase decision.

After verifying that the serial number is valid or the serial number is not belongs to a product which sales is not supported by server 3, for reasons such as it is sold by a seller not related to server 3, the server 3 will also grant the user of device 1 access to a customer service representative, to handle his enquiry request.

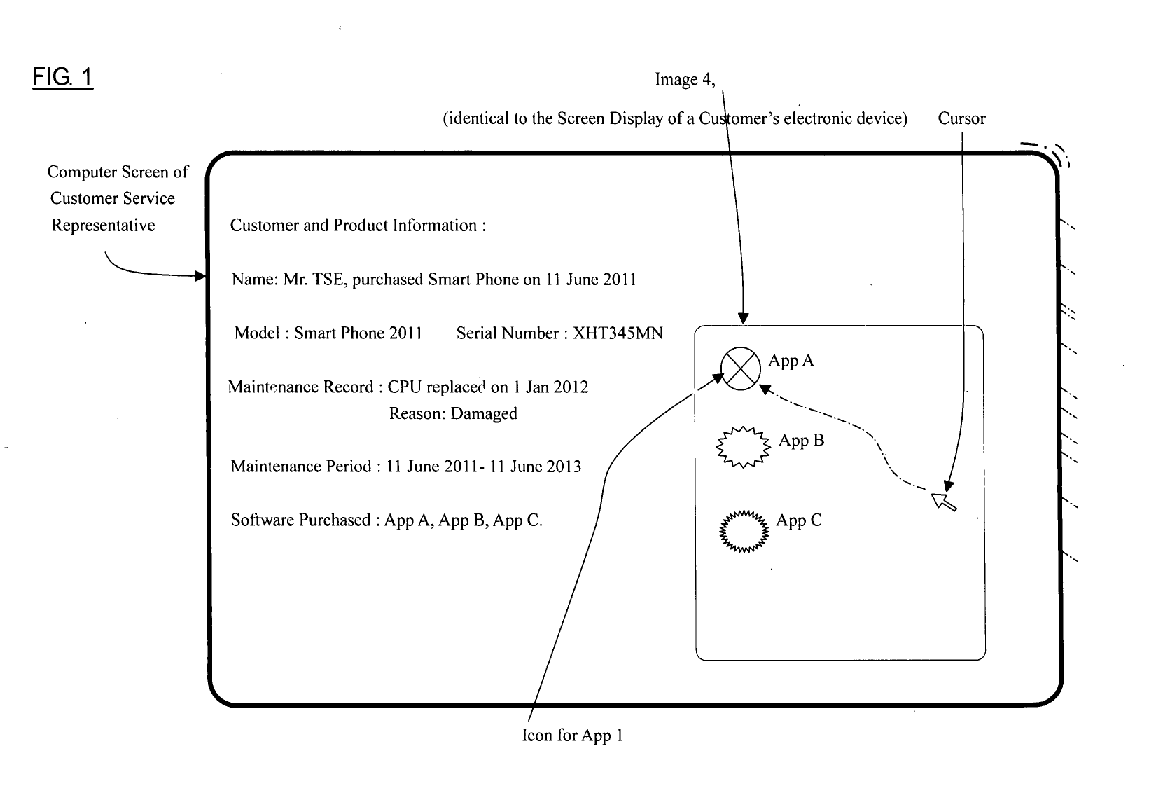

Specifically, server 3 will activate the computer of a customer service representative to display a record to inform what product electronic device 1 is (e.g., a “smart phone”) and if the device is purchased and who buys it (“Mr. Tse”) etc., refer to FIG. 1. The customer service representative's computer is a slave terminal of the server 3, under control of the server 3.

In handling the user's enquiry request, the server 3 assigns a priority for the user's enquiry request, among requests from other users, basing on the status of sales of the device 1, that is, “sold”, “in trial period”, “in maintenance period”, etc. The enquiry request will be granted a highest priority if the device is not “sold”, or “in trial period”, a lower priority if “in maintenance period” and the lowest priority if “maintenance period has expired”. The server 3 will assign customer service representatives to handle enquiry requests according to their priorities, those enquiries with higher priorities will be assigned with a customer service representative, and when no customer service representative is available, an enquiry request will be handled by the server 3 itself by using artificial intelligent software, detail will be explained herein below.

The specific application program S in device 1 will send information of screen display of touch screen 2 of device 1, to the server 3, so that the server 3 can cause the representative's computer screen to display an exact image 4 of the screen display of device 1 and update the image 4 from time to time, please refer to FIG. 1. And, if program S receives a specific command from a user, it will put device 1 under the control of the server 3.

Specifically, when the server 3 detects the customer service representative moves the cursor into the image 4 of screen display, it will immediate send information of the cursor position in the image 4, to program S, so as to cause program S to create a cursor on the touch screen 2 of device 1, at a position corresponding to the position of the customer service representative's cursor in the image 4. Further, under the control of the server 3, program S will move the cursor it created on touch screen 2 of device 1, in accordance with any movement of the customer service representative's cursor in the image 4. Still further, if the customer service representative clicks the left button of the computer's mouse, the server 3 will respond by sending a command signal to program S to highlight the cursor by, says, changing the colour of the cursor. After having highlighted the cursor for a short period of time, says, 2 seconds, the server 3 will also cause program S to send a signal to the operation system of device 1 which is a signal equivalent to that the operation system of device 1 would receive if a user taps the touch screen 2 with a finger at the position of the cursor. By way of example only, if the customer service representative moves his cursor to icon of App A on the image 4, and left clicks the mouse, he will cause App A which is an application program, to be executed in device 1, as according to the design of device 1, App A will be executed when a user taps its icon on touch screen 2. In this way, the customer service representative can show a user of device 1, how to use different functions of the device 1, by cursor activities, and the user can understand from the cursor activities he has seen, that what finger movements on the touch screen 2 of device 1 that he has to do in order to cause device 1 to perform the same functions. Verbal communication between the user and the representative takes place simultaneously, by transmitting digitized voice messages via the Internet connection between device 1 and the server 3.

And, if after a cursor has been caused to present in the image 4 of the customer service representative's computer screen and a corresponding cursor displayed on the touch screen 2 of device 1, the server 3 detects the customer service representative touches a specific key on keyboard, the server 3 will create two highlighted cursors at the position of the original cursor, in the manner as mentioned above. Then, server 3 will move the two cursors apart from each other, at a speed corresponding to the speed the customer service representative moves his mouse and one cursor will move in according to the direction of the movement of the mouse whereas the other cursor will be in an opposite direction. And, as in the manner mentioned above, program S will keep sending signals to the operation system of device 1 which is equivalent to that the operation system would receive if a user touches the touch screen 2 with two fingers at the position of the two highlighted cursors and follows the movements of the two cursors with his two fingers, thereby, simulating a multi-touch gesture of two moving apart fingers on a touch screen.

Alternatively, the customer service representative may use a computer with a touch screen, to move the cursor on touch screen 2 of device 1, by touching with his finger(s) on the image 4 shown on his own touch screen. Specifically, when the server 3 detects the image 4 is touched it will send a signal indicating the position being touch on the image 4 to program S, program S will create a highlighted cursor on the touch screen 2 of device 1, at a corresponding position and send a signal to the operation system of device 1 which is a signal equivalent to that the operation system of device 1 would receive if a user of device 1 taps touch screen 2 with a finger at the position of the cursor, in the manner as described above.

In a second embodiment, the customer service representative does not teach the user how to use device 1, rather, the server 3 is equipped with software with artificial intelligence to perform at least a part of the job the customer service representative would have to do. Specifically, the customer service representative talks with the user of device 1 via Internet to find out what is the problem the user has in using device 1, or the server 3 receives verbal instruction directly from user, which may be in form of digitized voice message sent via the Internet connection between server 3 and device 1. Server 3 will determine the meaning of the voice message through speech recognition and artificial intelligence techniques. The customer service representative/the server 3 will then select one out of a plurality of demonstration programs, for demonstrating to the user how to use a particular function of device 1. When the selected demonstration program is executed, it will receive the image of screen display of device 1 from program S, and recognize from the image, by pattern recognition, the icon A representing an application program, says program A, responsible for that particular function and obtain the position of the icon A in display of device 1. Then, the selected demonstration program will cause program S in device 1 to create a cursor on touch screen 2 of device 1, at a location remotely from icon A initially, then cause the cursor to move to the position of or in close proximity to icon A and further then, highlight the cursor and then wait for a fraction of a second to a few seconds, says, 2 seconds, then, send a signal to the operation system which is a signal equivalent to that the operation system of device 1 would receive if a user taps touch screen 2 with a finger at the position of the cursor.

It should be noted that highlighting the cursor in this way can better attract the attention of the user.

Alternatively, it may well be icon A itself, rather than the cursor, is being highlighted, further, in this case, the creation and movement of cursor to icon A, may be omitted.

In an alternative embodiment, the operation system of device 1 as mentioned above is also for creating cursor and the image of icons of application programs on touch screen 2. And, the selected demonstration program as mentioned above causes the program S to send a specific command signal to the operation system, so as to receive the position of the icons in the touch screen 2 of device 1 from the operation system. Further, the operation system is also responsible for creating a virtual keyboard on the touch screen 2, and the operation system will also supply the positions of the keys in the keyboard to the program S. Program S will send the positions received to the selected demonstration program to facilitate the selected demonstration program to cause the operation system to create and move a cursor to a particular icon/key and cause the cursor be highlighted and generate a signal to the operation system equivalent to that the operation system would receive if a user touches the icon/key, in the manner as disclosed above.

Alternatively, the selected demonstration program does not obtain the positions of the icons or keys from the operation system at all, rather it causes program S to send commands to the operation system to specify the position of a cursor in related to a particular icon or key on touch screen 2, such a command may be in the form of, “create a cursor at a position plus or minus (+/−) N pixels distance vertically and plus or minus (+/−) M pixels distance horizontally from a particular icon or key”, herein N, M are integers and “pixel” is used as basic unit of distance measurement on touch screen 2.

And, after the cursor is created, the selected demonstration program moves the cursor in the manner as mentioned above by issuing similar commands with values of M and N therein being changed.

Still further, the selected demonstration program may simply issue a signal to the operation system identifying icon A, and then operation system will generate the above-mentioned command signals itself automatically, to itself, without relying on the selected demonstration program, for creating, moving and highlighting the cursor.

It should be note that, the manner of creation of cursor on touch screen 2 by the server 3 as taught herein above is merely for the purpose of showing the user how to use his finger(s) to touch the touch screen 2 and there is no cursor originally on touch screen 2 and when device 1 is in normal use, the device 1 is to be controlled by finger touching the touch screen 2, and no cursor will be shown on touch screen 2. Note that the present invention is equally usable on touch screen devices which support mouses and display cursors.

After program A is executed, the selected demonstration program will further demonstrate how to use the program A by causing further similar cursor activities on the touch screen 2 of device 1. By way of example, suppose that program A is for writing notes, with 4 major functions, namely as, a) creating a new file or opening an existing file; b) writing messages into the file; c) saving and closing the file; d) deleting the file. And, if the instructions received from the user as mentioned above, is a request for a demonstration of writing a file, then the demonstration program will cause program S to create a new file, write some words into the new file; and then close and delete the file, in device 1. However, as only one function, that is, “writing into a file” is requested by the user to be demonstrated, the demonstration program will perform the other functions not requested to be demonstrated, but have to be performed in order that the requested function can be demonstrated, that is, “creating a new file”, “closing and deleting the file”, at its full pace. For example, when the demonstration program has to actuate a soft or virtual button created by program A on touch screen 2, the demonstration program will directly cause program S to send a signal to program A which is a signal equivalent to that program A would receive if a user taps the soft or virtual button, without any cursor activities, or at least the unnecessary cursor activities and other related activities such as highlighting the cursor, may be performed at a greater speed or in a shorter time, than that performed for the function required by user to demonstrate.

It should be noted that the above embodiments are given by way of example only, and it will be obvious to those skilled in the art that various changes and modifications may be made without departing from the spirit of the present invention.

What is claimed is:

1. An apparatus for demonstrating how to use an electronic device, comprising:
first means for highlighting a display screen of said electronic device at a position of or in close proximity to a first object displayed on said display screen, for a predetermined period of time;
second means for causing said electronic device to perform a function that would be performed if said first object was clicked or tapped by a user, without a said click or tap, after said highlighting.

2. An apparatus as claimed in claim 1, wherein said apparatus exists in said electronic device.

3. An apparatus as claimed in claim 1, wherein said apparatus means exists in a device other than said electronic device.

4. An apparatus as claimed in claim 1, wherein said first means being for highlighting said first object for said predetermined period of time, before said function being caused to be performed.

5. An apparatus as claimed in claim 1, wherein said first means comprising:
means for obtaining position of said first object displayed on said display screen of said electronic device;
means for causing a second object to be created on said display screen, at a position different from that of said first object, then moving said second object to said first object.

6. An apparatus as claimed in claim 5, wherein further comprising means for highlighting said second object on said display screen for said predetermined period of time, before said function being caused to be performed.

7. An apparatus as claimed in claim 5, wherein said position of said first object is obtained, by informing by a program; said program being responsible for causing said first object to be created on said position on said display screen.

8. An apparatus as claimed in claim 5, wherein further comprising fourth means for determining said position of said first object on said display screen, by obtaining from said electronic device an image of screen display of said electronic device, and then performing pattern recognition for finding out the position of said first object on said image.

9. An apparatus as claimed in claim 5, wherein said second object being a cursor.

10. An apparatus as claimed in claim 1, wherein said apparatus being for causing said electronic device to perform a number of interrelated-functions, and further at least one of said number of functions being performed at a lower pace than the others.

11. An apparatus as claimed in claim 10, wherein said at least one of said number of functions being selected by a user of said electronic device.

12. A method for demonstrating how to use an electronic device, comprising the steps of:
highlighting a display screen of said electronic device at a position of or in close proximity to a first object displayed on said display screen, for a predetermined period of time;
causing said electronic device to perform a function that would be performed if said object was clicked or tapped by a user, without a said click or tap, after said highlighting.

13. A method as claimed by claim 12, wherein said highlighting step comprising the sub-steps of:
obtaining position of said first object displayed on said display screen of said electronic device;
causing said electronic device to create a second object on said display screen, at a position different from that of said first object, then moving said second object to said first object.

14. A method as claimed by claim 12, wherein said highlighting step said second object on said display screen is being highlighted for said predetermined period of time, before said function being caused to be performed.

14. A method as claimed by claim 12, wherein said highlighting step said first object on said display screen is being highlighted for said predetermined period of time, before said function being caused to be performed.

15. A method as claimed by claim 12, wherein said method being for causing said electronic device to perform a number of interrelated-functions, and further at least one of said number of functions being performed at a lower pace than the others.

16. A method as claimed by claim 15, wherein said at least one of said number of functions being selected by a user of said electronic device.

17. A method as claimed by claim 13, wherein said position of said first object is obtained, by informing by a program; said program being responsible for causing said first object to be created on said position on said display screen.
